(19) United States
(12) Patent Application Publication
(10) Pub. No.: US 2015/0091521 A1
(43) Pub. Date: Apr. 2, 2015

(54) CHARGING STATION FOR AN ELECTRICALLY POWERED VEHICLE AND CHARGING METHOD

(71) Applicant: SIEMENS AKTIENGESELLSCHAFT, Muenchen (DE)

(72) Inventors: MANUEL BLUM, OTTOBRUNN (DE); THOMAS KOMMA, OTTOBRUNN (DE); MIRJAM MANTEL, MUENCHEN (DE); MONIKA POEBL, MUENCHEN (DE)

(21) Appl. No.: 14/499,483

(22) Filed: Sep. 29, 2014

(30) Foreign Application Priority Data
Sep. 27, 2013 (DE) 102013219538.9

(51) Int. Cl. B60L 11/18; H02J 7/00

(52) U.S. Cl. CPC B60L 11/1838; B60L 11/1812; B60L 11/182; H02J 7/007
USPC 320/108; 320/137; 320/162

(57) ABSTRACT

A charging station transfers energy to an electrically powered vehicle which is wirelessly power-coupled to the charging station. The station has terminal for an electrical energy source, an inverter and an electronic coil connected to the inverter for providing energy for the wireless energy-transferring coupling by way of an alternating magnetic field. For that purpose the inverter is configured to apply an alternating electric voltage to the electronic coil in a resonance mode. The charging station has a detection unit and a control unit, the detection unit detects a malfunction relating to the transfer of energy during the wireless energy-transferring coupling of the electrically powered vehicle and to provide a fault signal. The control unit terminates the transfer of energy by way of the alternating magnetic field on the basis of the malfunction signal.

### CROSS-REFERENCE TO RELATED APPLICATION

This application claims the priority, under 35 U.S.C. §119, of German patent application 10 2013 219 538.9, filed Sep. 27, 2013; the prior application is herewith incorporated by reference in its entirety.

### BACKGROUND OF THE INVENTION

### Field of the Invention

The present invention relates to a charging station for transferring energy from the charging station to a wirelessly power-coupled electrically powered vehicle. The charging station comprises a terminal for an electrical energy source, an inverter and an electronic coil connected to the inverter for providing energy for the wireless electric coupling by way of an alternating magnetic field. The inverter is configured to apply an alternating electric voltage to the electronic coil in a resonance mode. In addition, the invention relates to a method for transferring energy from a charging station to an electrically powered vehicle which is power-coupled to the charging station with cordless coupling, the energy being transferred from the charging station to the electrically powered vehicle by means of an alternating magnetic field provided by an electronic coil, for which purpose an alternating electric voltage is applied to the electronic coil in a resonance mode by an inverter and the charging station draws electrical energy from an electrical energy source. Lastly, the invention relates also to a computer program product comprising a program for a computer unit of a charging station.

Charging stations of the generic type and methods for the operation thereof for the wireless transfer energy by means of an alternating magnetic field are known in principle, so separate verification in printed publications is not required for these. Charging stations of the generic type are used for supplying an electrically powered vehicle with energy during a charging operation so that the electrically powered vehicle can perform its intended function. The electrically powered vehicle needs the energy for drive operation.

The energy is provided by way of the alternating magnetic field of the charging station, which for its part is connected to an electrical energy source, for example to a public energy supply network, to an electric generator, to a battery and/or similar. The charging station generates the alternating magnetic field while receiving electrical energy from the electrical energy source. The electrically powered vehicle captures the alternating magnetic field by way of a suitable coil arrangement, draws energy from it and provides electrical energy on the vehicle side, in particular in order to supply electrical energy to an electrical energy store of the vehicle and/or an electric machine of a drive apparatus of the vehicle.

One way of feeding the energy from the charging station to a charging device of the vehicle is to establish an electrical connection as an energy-transferring coupling by means of a cable between the vehicle and the charging station. In addition, it is known, according to a further option, for a wireless energy-transferring coupling to be established that avoids the need for a complex mechanical connection via cable. To this end, a coil circuit with in each case at least one electronic coil is usually provided on the charging-station side and on the vehicle side respectively, which coil circuits are arranged during a charging process substantially opposite one another and, using an alternating magnetic field, make an energy-transfer coupling possible. Such an arrangement is described, for example, in Korean published patent application KR 10 2012 0 016 521 A.

In systems in which energy is transferred by means of an alternating magnetic field, also referred to as inductive energy transfer, changes in energy consumption may occur on the vehicle side during the charging process, the changes not being caused by the charging station and therefore not being known on the charging-station side. If for example the electrically powered vehicle is an electric vehicle or a hybrid vehicle, a disconnection of an electrical energy store, in particular of an accumulator of the electrically powered vehicle, may occur during the charging process. For example, the accumulator may be separated by a contactor from an electrical system of the electrically powered vehicle, the separation occurring for a wide variety of possible reasons. In such a case, also known as load shedding, on the charging-station side energy continues to be transferred to the electrically powered vehicle, which may among other things result in a rapid rise in electric voltage on the vehicle side. As a result, on-board power electronics, which are necessary for operation of the electrically powered vehicle in its intended application, may be damaged. Further on-board system components may also be damaged.

It is known in the prior art in such a case to provide a protective circuit on the vehicle side in the form of an overvoltage protection which limits the voltage level on the vehicle side. Such protective circuits can, however, generally be operated only for a limited time. The on-board power electronics must then be electrically separated from other components of the electrically powered vehicle, for example by means of fuses or similar.

In addition, it is known for the load shedding on the vehicle side to be determined and to be reported via a communication channel to the charging station. To this end, it is possible on the vehicle side to use either a measurement of the load shedding or else an analysis of a corresponding signal causing the load shedding. At the charging station end, the provision of energy can then be terminated or limited. In this scenario, it proves disadvantageous for a comparatively long time to pass before receipt of the report at the charging station. During this period, the charging station continues to provide energy by means of the alternating magnetic field, and thus continues to input power on the vehicle side. For this reason, a correspondingly suitable high-speed communication channel between the charging station and the electrically powered vehicle is required. In addition, high demands will be placed on this communication channel, and it is safety-critical.

The currently known procedures thus include firstly an overvoltage protection which must be coupled with a communication channel that continues to be very fast and reliable. This is not only complex, but can also be prone to malfunctions, especially where a charging station or perhaps multiple charging stations in close proximity to one another are supplying energy to multiple electrically powered vehicles in parallel.

### SUMMARY OF THE INVENTION

It is accordingly an object of the invention to provide a charging station for an electric-drive vehicle which overcomes the disadvantages of the heretofore-known devices of this general type and which provide for an improved charging operation.

With the above and other objects in view there is provided, in accordance with the invention, a charging station for transferring energy from the charging station to a wirelessly power-coupled electrically powered vehicle, the charging station comprising:

a terminal for an electrical energy source;

an inverter connected to the terminal;

an electronic coil connected to the inverter and configured for providing energy by wireless energy-transfer coupling via an alternating magnetic field, the inverter being configured to apply an alternating electric voltage to the electronic coil in a resonance mode;

a detection unit configured to detect a malfunction relating to the transfer of energy during the wireless energy-transfer coupling of the electrically powered vehicle and to generate a malfunction signal; and

a control unit connected to the detection unit and configured to terminate an energy transfer by way of the alternating magnetic field based on the malfunction signal.

With the above and other objects in view there is also provided, in accordance with the invention, a method of transferring energy from a charging station to an electrically powered vehicle that is wirelessly power-coupled to the charging station. The novel method comprises the following steps:

drawing electrical energy from an electrical energy source;

applying an alternating electric voltage by an inverter powered by the electrical energy to an electronic coil in resonance mode;

generating with the coil an alternating magnetic field for transferring the energy from the charging station to the electrically powered vehicle;

monitoring for a malfunction relating to the transfer of energy during the wireless energy-transferring coupling of the electrically powered vehicle, and on detection of a malfunction, terminating a provision of energy by way of the alternating magnetic field.

On the device side, the invention proposes in particular that the charging station has a detection unit and a control unit, the detection unit being configured to detect a malfunction relating to the transfer of energy during the wireless energy-transferring coupling of the electrically powered vehicle and to provide a malfunction signal and the control unit being configured to terminate the provision of energy by means of an alternating magnetic field on the basis of the malfunction signal. On the method side, it is proposed correspondingly that a malfunction relating to the transfer of energy during the wireless energy-transferring coupling of the electrically powered vehicle is detected and the provision of energy by means of the alternating magnetic field is terminated.

The invention thus uses parameters on the charging-station side in order for example to be able to detect load shedding on the vehicle side. This saves on the need for a separate communication channel as well as detection means in the electrically powered vehicle. In addition, the fact that a communication channel is no longer required also means increased reliability and resistance to malfunctions, namely because the transfer of information via the communication channel can be dispensed with altogether. Consequently all the disadvantages associated with this also no longer apply. In addition, this of course also means savings in terms of time and money. At the same time, the communication channel can of course also continue to be used together with on-board detection means in order to be able to implement redundancy or such like.

As compared to the prior art, the invention makes use of properties of the physical coupling of a system consisting of the charging station and the electrically powered vehicle during charging. In such a system, load shedding represents a significant system change. The invention makes use of the fact that such a system change can be detected using parameters and/or system variables which change significantly on the charging-station side. These parameters on the charging-station side may, according to one embodiment, be for example a phase shift or a phase position between a coil current of the electronic coil on the charging-station side and an alternating voltage provided by the inverter on the charging-station side, an input current of the charging station, an operating frequency of the system consisting of the inverter and the electronic coil in resonance mode, or similar.

The detection unit can for this purpose have a corresponding sensor with which the corresponding parameter on the charging-station side can be measured. In addition, the detection unit can of course also be fashioned in one piece with the control unit. Both components can be integrated individually or possibly together in a controller for the inverter. Both the detection unit and the control unit may consist of an electronic circuit which may for example have a hardware circuit but also a computer unit, combinations thereof and/or similar.

The malfunction relating to the transfer of energy may for example be the load shedding on the vehicle side or perhaps another malfunction in connection with the consumption of energy from the alternating magnetic field. For example, it is also possible in this way to detect the removal of the electrically powered vehicle, whereupon the wireless energy-transferring coupling of the electrically powered vehicle can be terminated. In particular, the alternating voltage provided by the inverter can be switched off for this purpose, whereupon the provision of the alternating magnetic field by the electronic coil is terminated.

If the detection unit detects such a malfunction, it preferably generates a malfunction signal, which it makes available for further use by the charging station, in particular by the control unit. The control signal can be an electrical signal, which can, for example, be an analog but also a digital signal. The malfunction signal preferably engages a controller for the inverter and prevents or terminates operation of the inverter in its intended application.

The invention takes into account the fact that on the charging-station side the inverter is operated with the electronic coil in particular in a resonance mode. This means that the optimal operating frequency and/or the frequency of the alternating electric voltage provided by the inverter is significantly influenced by features of the alternating magnetic field generated by the electronic coil. The resonance mode is achieved by additionally connecting a capacitor to the electronic coil. The capacitor can be connected to the electronic coil for example in series but also in parallel.

Inductive energy transfer or wireless energy-transferring coupling within the meaning of the invention is a coupling for the purpose of transferring energy which makes it possible to transfer energy at least unidirectionally from an energy source to an energy sink. The energy source may, for example, be a public energy supply network, an electric generator, a solar cell, a fuel cell, a battery, combinations thereof and/or similar. The energy sink may, for example, be a drive apparatus of the electrically powered vehicle, in particular an electric machine of the drive apparatus and/or an electrical energy store of the drive apparatus, for example an accumulator or similar. However, bidirectional energy transfer may also be provided, i.e. energy transfer alternately in both directions. This purpose is served by, among other things, the charging station, which is designed to transfer energy to the electrically powered vehicle, for which purpose it draws electrical energy from an energy source to which it is electrically connected.

Wireless energy-transferring coupling or inductive energy transfer within the meaning of the invention means that no mechanical connection needs to be provided between the charging station and the electrically powered vehicle in order to establish an electrical coupling. In particular, the establishment of an electrical connection by means of a cable can be avoided. Instead, the energy-transferring coupling is realized essentially solely on the basis of an energy field, preferably an alternating magnetic field.

The charging station is therefore configured to generate such an energy field, in particular an alternating magnetic field. It is correspondingly provided on the vehicle side that an energy field of this kind or an alternating magnetic field can be captured and energy obtained therefrom for operation of the electrically powered vehicle in its intended application. By means of the charging device of the vehicle, the energy supplied by means of the energy field, in particular the alternating magnetic field, is converted into electrical energy which can then be stored preferably in the energy store of the vehicle for operation of the vehicle in its intended application. For this purpose, the charging device may have a converter, which converts the electrical energy taken from the alternating magnetic field by means of the coil and fed to the converter into a form of electrical energy suitable for the vehicle, for example rectifies it, transforms its voltage, or similar. In addition, the energy may also be fed directly to the electric machine of the drive apparatus of the vehicle. The energy-transferring coupling thus essentially serves the purpose of transferring energy, and not primarily of transferring information. Accordingly, the means for implementing the invention are, unlike a wireless communication connection, designed for a correspondingly high power throughput.

A key element for the wireless energy-transferring coupling, in particular by means of the alternating magnetic field, is the electronic coil, which may sometimes also consist of a plurality of electronic coils, which on the charging-station side serves to generate the alternating magnetic field and on the vehicle side is suffused by the alternating magnetic field and on the vehicle side provides electrical energy at its corresponding terminals. Correspondingly, on the charging-station side, an alternating voltage giving rise to an alternating current is applied to the electronic coil such that the electronic coil provides the alternating magnetic field by means of which energy can be emitted. Via the alternating magnetic field, the electronic coil of the charging station is coupled to the electronic coil of the electrically powered vehicle during the charging process.

The coil usually has a winding comprising several turns of an electrical conductor, the winding usually comprising or enclosing a ferromagnetic body which frequently consists of a ferrite. By means of the ferromagnetic body, the magnetic flux can be guided in a desired manner such that the effectiveness of the energy-transferring coupling can be increased on the basis of the alternating magnetic field between the coil circuits of the charging station and of the electrically powered vehicle.

The electrical conductor forming the turns of the electronic coil is frequently embodied as a so-called high-frequency litz wire, i.e. it consists of a plurality of individual conductors or wires electrically insulated from one another, which are combined in an appropriate manner to form the conductor. The result of this is that in frequency applications such as in the case of the invention, a current displacement effect is reduced or substantially prevented. In order to be able to improve as even as possible a distribution of current between the individual wires of the high-frequency litz wire, a twisting of the individual wires is usually also provided. The twisting may also include forming bundles of a certain number of individual wires which are in themselves twisted, and then likewise twisting these bundles to form the electrical conductor.

According to a further aspect of the invention, the detection comprises a comparison of a parameter relating to the energy transfer and/or a change in the parameter with a reference value. In particular, a differential change can be analyzed. To this end, the detection circuit may comprise a suitable comparator circuit which can provide the desired functions. The reference value can be fixedly or adjustably predefined. The latter makes it possible to adapt the charging station to individual requirements. The invention preferably uses the fact that the parameter, in particular its change, is faster than regulation of the optimal operating frequency. In this way, a clear signal for evaluation can be achieved by means of the detection unit.

It is particularly advantageous if the parameter consists of a phase shift between the coil current of the electronic coil and an alternating voltage provided by the inverter for the electronic coil. In this way, it is possible to achieve reliable detection of the malfunction relating to the transfer of energy.

In addition, the parameter may alternatively or perhaps additionally consist of a frequency of the alternating voltage, in particular the operating frequency. Furthermore, the parameter may also consist of an input current of the charging station, in particular of an effective power determined therefrom, and/or similar. The input current of the charging station is the current which is provided by the energy source to which the charging station is connected.

Correspondingly, the invention also comprises a generic computer-program product, the product having program code segments of a program for executing the method according to the invention, if the program is executed by the computer unit of the control device. The above-mentioned computer-program product may be fashioned as a computer-readable storage medium. In addition, the program may be directly loadable into an internal memory of the computer unit. In this way, it is for example possible to download the program from a network from a data source, for example a server, and to load said program into an internal memory of the computer unit so that the computer can execute the program.

The computer program preferably comprises a computer-readable medium on which the program code segments are stored. Such a computer-readable medium may for example be a memory chip, a compact disk, a USB stick, or the like.

Other features which are considered as characteristic for the invention are set forth in the appended claims.

Although the invention is illustrated and described herein as embodied in charging station for an electrically powered vehicle and a charging method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic graph representing a change in a current phase position in the event of load shedding during a charging operation of an electrically powered vehicle at a charging station according to the invention;

FIG. 2 shows a schematic representation of a phase profile in the event of load shedding as in FIG. 1 without a disconnection according to the invention;

FIG. 3 shows a schematic representation of a time-differentiated signal profile of the phase profile shown in FIG. 2, which shows a signal that is detectable by a detection unit; and

FIG. 4 is a highly diagrammatic illustration of a charging station and a vehicle disposed in a charging position.

### DETAILED DESCRIPTION OF THE INVENTION

Referring now to the figures of the drawing in detail and first, particularly, to FIG. 4 thereof, there is shown simplistic diagram of a charging station 1 for transferring energy from the charging station 1 to an electrically powered vehicle 2 which is wirelessly power-coupled to the charging station 1. The vehicle is provided with a floor board charging assembly 2′ in this case. The charging station 1, which is disposed in the floor beneath the vehicle, has a terminal 3 for an electrical energy source, which in the present case is a public energy supply network or a mains. The charging station 1 further comprises an inverter 4 as well as an electronic coil 5. The electronic coil 5 being connected to said inverter 4, for providing power for wireless energy-transferring coupling by way of an alternating magnetic field. For this purpose, the inverter 4 is configured to apply an alternating electric voltage to the electronic coil 5 in a resonance mode.

The charging station 1 has a detection unit 6 and a control unit 7, the detection unit being configured to detect a malfunction relating to the transfer of energy during the wireless energy-transferring coupling of the electrically powered vehicle 2. If such a malfunction is detected, the detection unit 6 provides a malfunction signal. The malfunction signal is available to the control unit 7.

The control unit 7 is configured to terminate the provision of energy by means of the alternating magnetic field on the basis of the malfunction signal. For this purpose, it is provided that the control unit 7 terminates the operation of the inverter 4 so that said inverter 4 no longer provides an alternating electric voltage for the electronic coil 5. An alternating magnetic field is then also no longer produced by means of the electronic coil 5. The provision of energy for the electrically powered vehicle is thereby terminated.

In the present case, detection by the detection unit 6 is effected by means of comparison of a parameter relating to the energy transfer, in particular in the present case a change in this parameter, relative to a reference value. The parameter in the present exemplary embodiment is a phase shift between a coil current of the electronic coil 5 and the alternating voltage provided by the inverter 4 for the electronic coil 5.

The parameter may also alternatively or additionally consist of a frequency of the alternating voltage or also of an input current of the charging station 1.

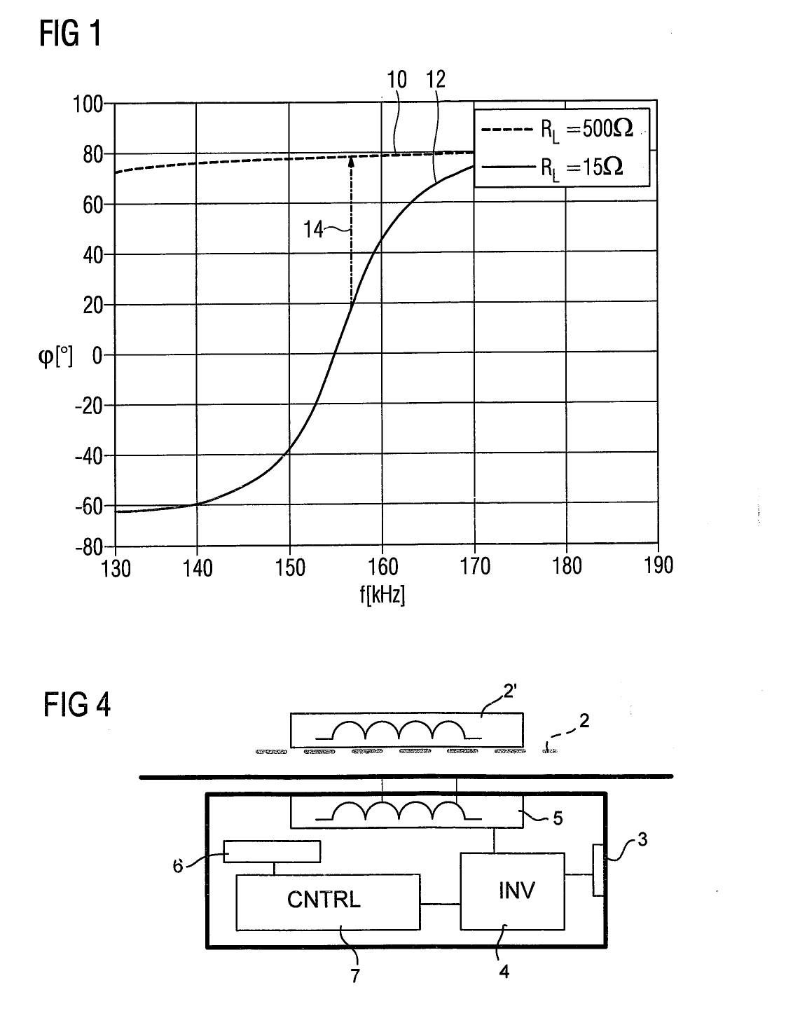

FIG. 1 shows by way of example for this exemplary embodiment a change in the current phase shift in the event of a load jump on the vehicle side from 15 ohms to 500 ohms. In the diagram shown in FIG. 1, the angle of the phase shift is given in degrees on the vertical axis. The horizontal axis shows the frequency of the alternating voltage provided by the inverter in kHz. A first graph 10 shows the phase shift in the case of a load resistance on the vehicle side of 500 ohms by means of a first graph 10. It can be seen that in the frequency band shown the phase shift at this load resistance is approximately 70 degrees at 130 kHz and approaches 80 degrees as the frequency increases. The phase shift is thus very high.

It can further be seen from FIG. 1 that at a load resistance of 15 ohms in the vehicle side, the phase shift at 130 kHz lies in the region of −65 degrees. Although the phase shift rises to positive values as the frequency increases, the phase shift always remains below the phase shift that occurs at a load resistance of 500 ohms. This is shown by the graph 12.

If at a frequency of 155 kHz there is, for example, a load jump from 15 ohms to 500 ohms because an accumulator is switched off on the vehicle side, the phase shift jumps from approximately 20 degrees to approximately 80 degrees, which is represented by the arrow 14. The invention makes use of this to detect this phase jump and from that to detect the malfunction relating to the transfer of energy during the wireless energy-transferring coupling of the electrically powered vehicle.

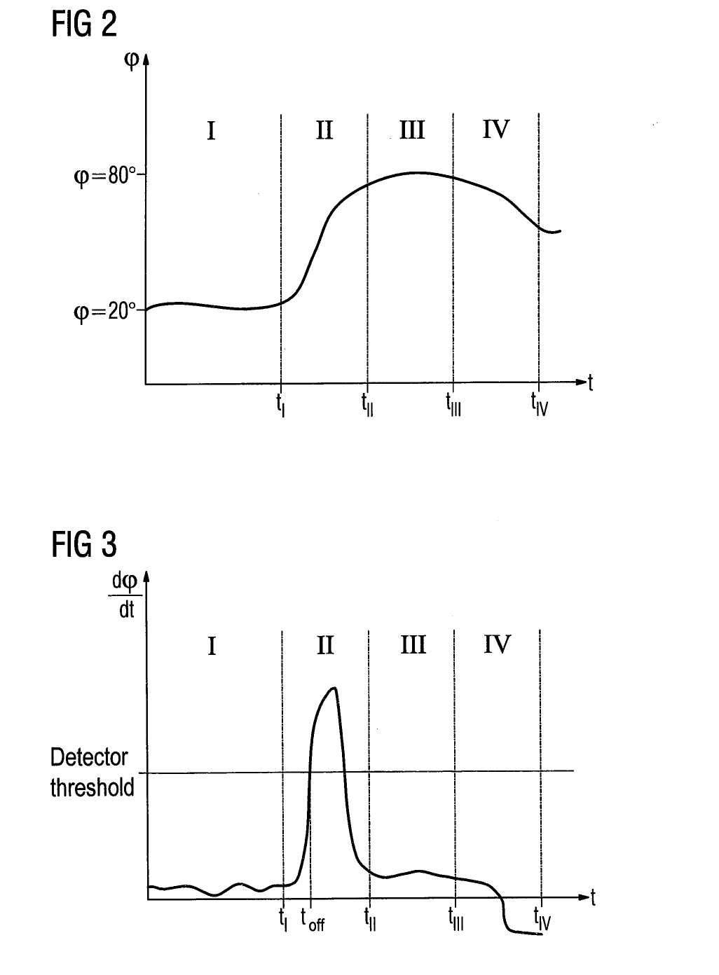

Thus, if a change occurs in the load conditions on the vehicle side, this results in a change in the phase position. If this change happens faster than a dynamic response of the regulator on the charging-station side to stabilize the phase situation, this system change is clearly detectable and is in all probability due to load shedding on the vehicle side. FIG. 2 shows the corresponding basic curve of the phase position or phase shift in the case of load shedding with regard to this exemplary embodiment, if no disconnection were to take place. For improved characterization of the change that has occurred, it may additionally be provided that the change determined be filtered by a differentiator with a delay (DT1 element).

FIG. 3 shows the corresponding change in the phase shift. Using this measurable information, it is possible to differentiate between uninterrupted operation, where phase changes can be corrected normally, and interrupted operation, which occurs in the case of load shedding.

In FIG. 2 and FIG. 3 the horizontal axes are time axes, on which the times t_{I}, t_{II}, t_{III} and t_{IV} are marked. These points in time form areas I, II, III and IV.

In FIG. 2, the angle of the phase shift φ is represented on the vertical axis, whereas in FIG. 3 its time derivative is represented on the vertical axis, i.e. dφ/dt is represented. FIG. 2 shows, in area I, the phase shift and its change in normal intended operation during charging of the electrically powered vehicle by means of the charging station. In area II, the load is shed on the vehicle side. In area III, new system parameters are achieved, which result in a corresponding phase shift. If the energy transfer is not shut down promptly, area IV of a process of correction by means of a phase regulator of the charging station begins. This leads to a fall in the phase position and to an increase in the energy transferred, which produces a corresponding overvoltage spike on the vehicle side.

The rapid change in area II can be seen very easily (FIG. 3). Due to this change, the power transfer can be disconnected. This time t_{off} is reached when dφ/dt reaches a detection threshold. The time between load shedding and termination of the provision of energy by means of the alternating magnetic field is limited only by the time for recording the measurement variables or parameters, the filtering of the phase position and the time delay in blocking control signals from the inverter and may lie in the region of a few microseconds.

In another exemplary embodiment, it may be provided that, in addition, the monitoring of an input current of the charging station or perhaps of a frequency of the alternating voltage provided by the inverter can be monitored.

The invention achieves targeted monitoring of the time behavior of certain parameters on the charging-station side in order to increase operating reliability, in particular the operating reliability of the electrically powered vehicle. There is no need for a separate communication channel between the charging station and the electrically powered vehicle and an on-board detection unit.

The preceding exemplary embodiment is intended merely to illustrate the invention and not to restrict it. Of course, a person skilled in the art will provide appropriate variations if required without departing from the core idea of the invention.

Individual features may, of course, also be combined with one another in any way as required. In addition, device features may, of course, also be indicated by corresponding process steps, and vice versa.

1. A charging station for transferring energy from the charging station to a wirelessly power-coupled electrically powered vehicle, the charging station comprising:
a terminal for an electrical energy source;
an inverter connected to said terminal;
an electronic coil connected to said inverter and configured for providing energy by wireless energy-transfer coupling via an alternating magnetic field, said inverter being configured to apply an alternating electric voltage to said electronic coil in a resonance mode;
a detection unit configured to detect a malfunction relating to the transfer of energy during the wireless energy-transfer coupling of the electrically powered vehicle and to generate a malfunction signal; and
a control unit connected to said detection unit and configured to terminate an energy transfer by way of the alternating magnetic field based on the malfunction signal.

2. A method of transferring energy from a charging station to an electrically powered vehicle that is wirelessly power-coupled to the charging station, the method comprising:
drawing electrical energy from an electrical energy source;
applying an alternating electric voltage by an inverter powered by the electrical energy to an electronic coil in resonance mode;
generating with the coil an alternating magnetic field for transferring the energy from the charging station to the electrically powered vehicle;
monitoring for a malfunction relating to the transfer of energy during the wireless energy-transferring coupling of the electrically powered vehicle, and on detection of a malfunction, terminating a provision of energy by way of the alternating magnetic field.

3. The method according to claim 2, wherein the detection comprises comparing a parameter relating to the energy transfer and/or a change in the parameter with a reference value.

4. The method according to claim 3, wherein the parameter consists of a phase shift between a coil current of the electronic coil and the alternating voltage provided by the inverter for the electronic coil.

5. The method according to claim 3, wherein the parameter consists of a frequency of the alternating voltage.

6. The method according to claim 3, wherein the parameter consists of an input current of the charging station.

7. A computer program product, comprising a non-transitory program for a computer unit of a charging station, wherein the program has program code segments of a program for executing the steps of a method according to claim 6, when the program is executed by the computer unit.

8. The computer program product according to claim 7, wherein the computer program product comprises a computer-readable medium on which the program code segments are stored in non-transitory form.

9. The computer program product according to claim 7, wherein the program is directly loadable into an internal memory of the computer unit.

10. A computer program product, comprising a non-transitory program for a computer unit of a charging station, wherein the program has program code segments of a program for executing the steps of a method according to claim 5, when the program is executed by the computer unit.

11. The computer program product according to claim 10, wherein the computer program product comprises a computer-readable medium on which the program code segments are stored in non-transitory form.

12. The computer program product according to claim 10, wherein the program is directly loadable into an internal memory of the computer unit.
